(19) United States
(12) Patent Application Publication
(10) Pub. No.: US 2024/0428042 A1
(43) Pub. Date: Dec. 26, 2024

(54) Active Chatbot System with Composite Finite State Machine and Method Thereof

(71) Applicants: SQ Technology (Shanghai) Corporation, Shanghai (CN); Inventec Corporation, Taipei City (TW)

(72) Inventor: Chuan-Cheng Chiu, Taipei City (TW)

(21) Appl. No.: 18/461,032

(22) Filed: Sep. 5, 2023

(30) Foreign Application Priority Data
Jun. 25, 2023 (CN) 202310754973.3

(51) Int. Cl. G06N 3/006

(52) U.S. Cl. CPC G06N 3/006

(57) ABSTRACT

An active chatbot system with composite finite state machine and a method thereof are disclosed. In the active chatbot system, a rough question message having a natural language structure is generated based on a client behavior state and an on-demand conversation setting, and the rough question message is inputted to a question optimization circuit to generate a precise question message, and the precise question message is transmitted to an artificial intelligence platform to obtain a corresponding answer message, the answer message is inputted to a trained emotional AI model to generate an emotional answer message and the emotional answer message is stored in an answer list, so that the emotional answer message matching the on-demand conversation setting can be filtered out as an on-demand conversation message, the on-demand conversation message is transmitted to the client-end host for output. Therefore, the technical effect of improving conversational flexibility and realism of chatbot can be achieved.

### CROSS-REFERENCE TO RELATED APPLICATION

This application claims the benefit of Chinese Application Serial No. 202310754973.3, filed Jun. 25, 2023, which is hereby incorporated herein by reference in its entirety.

### BACKGROUND OF THE INVENTION

### 1. Field of the Invention

The present invention relates to a chatbot system and a method thereof, and more particularly to an active chatbot system with composite finite state machine, and a method thereof.

### 2. Description of the Related Art

In recent years, with the popularization and vigorous development of artificial intelligence (AI), various AI applications have sprung. Among the AI applications, chatbots attract the most attention.

Generally speaking, a conventional chatbot uses a passive chat mode for man-machine dialogue, that is, when the user sends a question, the conventional chatbot replies an answer according to the question; even if the most popular large language model (LLM) is used, when the user does not ask a question, the conventional chatbot does not make any response; at most, the conventional chatbot actively replies to a welcome message or guidance message at the initial stage. Although the chat robot using LLM has made great progress in understanding and generating natural language, it still lacks the ability to perceive the user's state and the real world, and the natural language generated by the conventional chatbot does not have rich emotions; the conventional chatbot can only answer specific questions or complete specific tasks in a standard way. There is a problem that the conventional chatbot has poor flexibility and realism.

For the above-mentioned reason, some manufacturers proposed to use the user's browsing records as a technical means of active question, for example, when the user browses a webpage for an item, the conventional chatbot can actively ask whether you want to buy this item or introduce this item in detail. Although this method can actively reply messages, its interactive manner is rigid and not humanized, and cannot be called chatting. The above-mentioned conventional chatbot still cannot effectively solve the problem of poor flexibility and realism.

Therefore, what is needed is to develop an improved solution to solve the problem of poor flexibility and realism of the conventional chatbot.

### SUMMARY OF THE INVENTION

An objective of the present invention is to disclose an active chatbot system with composite finite state machine and a method thereof, to solve the conventional problem.

In order to achieve the objective, the present invention provides an active chatbot system with composite finite state machine, includes an artificial intelligence platform, a client-end host, and a server-end host.

The artificial intelligence platform is configured to receive a precise question message through an application programming interface (API) and input the precise question message to a large language model to generate an answer message, and transmit the answer message through the application programming interface. The client-end host includes at least one sensor, a first non-transitory computer readable storage medium and a first hardware processor. The at least one sensor is configured to continuously sense at least one of a physiological state, a facial expression and a body movement, to generate a client behavior state. The first non-transitory computer readable storage medium is configured to store a plurality of first computer readable instructions. The first hardware processor is electrically connected to the first non-transitory computer readable storage medium and the at least one sensor, and configured to execute the plurality of first computer readable instructions to make the client-end host continuously transmit the client behavior state and on-demand conversation setting, wherein the on-demand conversation setting comprises a time message and a filtering parameter.

The server-end host is connected to the client-end host and configured to receive the client behavior state and the on-demand conversation setting. The server-end host includes a question optimization circuit, a second non-transitory computer readable storage medium, and a second hardware processor.

The question optimization circuit includes a plurality of registers for storing states, a first combinational logic circuit for determining a state transition and a second combinational logic circuit for determining an output to form a first finite state machine and a second finite state machine which are connected in series, wherein the first finite state machine receives a rough question message and the answer message, an output of the first finite state machine is used as an input of the second finite state machine, and the second finite state machine outputs the precise question message to the artificial intelligence platform through the application programming interface. The second non-transitory computer readable storage medium is configured to store a plurality of second computer readable instructions. The second hardware processor is electrically connected to the second non-transitory computer readable storage medium and the question optimization circuit, and configured to execute the plurality of second computer readable instructions to make the server-end host execute: generating a rough question message having a natural language structure based on the received client behavior state and on-demand conversation setting, and inputting the rough question message to the question optimization circuit; after the question optimization circuit inputs the precise question message to the artificial intelligence platform, receiving the answer message corresponding to the precise question message from the artificial intelligence platform, and inputting the answer message to a trained emotion AI model to generate an emotional answer message, and storing the emotional answer message to an answer list; automatically filtering out the emotional answer message matching the time message and the filtering parameter from the answer list as the on-demand conversation message generated based on the on-demand conversation setting, and transmitting the on-demand conversation message to the client-end host for output.

In order to achieve the objective, the present invention discloses an active chatbot method with composite finite state machine, and the active chatbot method includes steps of: connecting a server-end host to an artificial intelligence (AI) platform and a client-end host; continuously sensing at least one of a physiological state, a facial expression and a body movement to generate a client behavior state through a sensor, by the client-end host; continuously transmitting the client behavior state and on-demand conversation setting to the server-end host, by the client-end host, wherein the on-demand conversation setting comprises a time message and a filtering parameter; generating a rough question message having a natural language structure based on the received client behavior state and on-demand conversation setting, and inputting the rough question message to a first finite state machine and a second finite state machine connected in series to perform parsing, and transiting states of the first finite state machine and the second finite state machine to generate a precise question message, by the server-end host, wherein the first finite state machine receives the rough question message and an answer message from the AI platform, an output of the first finite state machine is inputted to the second finite state machine, the second finite state machine outputs the precise question to the AI platform through an application programming interface (API) of the AI platform; inputting the precise question message to the large language model to generate the answer message, and transmitting the answer message to the server-end host through the application programming interface, by the artificial intelligence platform; receiving the answer message corresponding to the precise question message from the artificial intelligence platform, inputting the answer message to a trained emotion AI model to generate an emotional answer message, and storing the emotional answer message to an answer list, automatically filtering out the emotional answer message matching the time message and the filtering parameter as an on-demand conversation message from the answer list, and transmitting the on-demand conversation message to the client-end host for output, by the server-end host.

According to the above-mentioned system and method of the present invention, the difference between the conventional technology and the present invention is that in the present the rough question message having the natural language structure is generated based on the client behavior state and the on-demand conversation setting, and the rough question message is inputted to the question optimization circuit to generate the precise question message, and the precise question message is transmitted to the artificial intelligence platform to obtain the corresponding answer message, the answer message is inputted to the trained emotional AI model to generate the emotional answer message and the emotional answer message is stored in the answer list, so that the emotional answer message matching the on-demand conversation setting can be filtered out as the on-demand conversation message, the on-demand conversation message is transmitted to the client-end host for output.

Therefore, the technical solution of the present invention is able to achieve the technical effect of improving conversational flexibility and realism of chatbot.

### BRIEF DESCRIPTION OF THE DRAWINGS

The structure, operating principle and effects of the present invention will be described in detail by way of various embodiments which are illustrated in the accompanying drawings.

FIG. 1 is a block diagram of an active chatbot system with composite finite state machine, according to the present invention.

FIGS. 2A and 2B are flowcharts of an active chatbot method with composite finite state machine, according to the present invention.

FIG. 3 is a schematic view of an active chatbot of the present invention.

FIG. 4 is a schematic view of a composite finite state machine of the present invention.

FIG. 5 is a schematic view showing an operation of actively filtering out an emotional answer message from an answer list, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

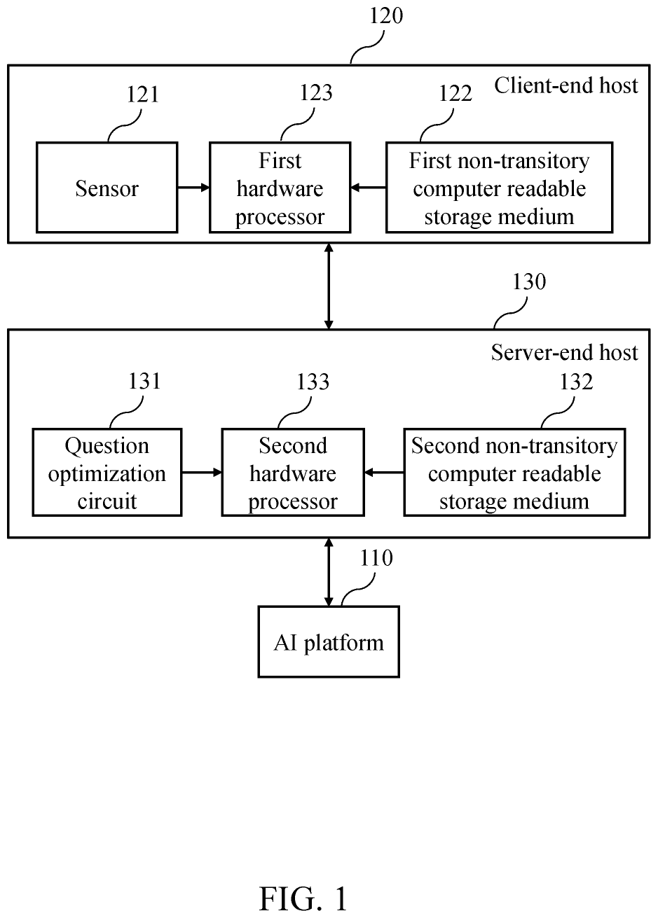

Please refer to FIG. 1, which is a block diagram of an active chatbot system with composite finite state machine, according to the present invention. As shown in FIG. 1, the active chatbot system includes an artificial intelligence platform 110, a client-end host 120, and a server-end host 130. The artificial intelligence platform 110 is configured to receive a precise question message through an application programming interface (API), and input the precise question message to a large language model (LLM) to generate an answer message, and transmit the answer message to the server-end host 130 through the application programming interface. In actual implementation, the artificial intelligence platform 110 uses a chatbot using a large language model, and the large language model can be, for example, generative pre-trained transformer, (GPT), paLM, Galactica, LLaMA, LaMDA or the like.

The client-end host 120 includes a sensor 121, a first non-transitory computer readable storage medium 122, and a first hardware processor 123. The sensor 121 is configured to continuously sense at least one of a physiological state, a facial expression and a body movement, to generate a client behavior state. In actual implementation, the sensor 121 senses physiological feature such as blood pressure, heartbeat, pulse, blood sugar, to determine the physiological state such as happy, excited, or depressed; in an embodiment, the sensor 121 can be used to determine a facial expression and mood by sensing human face and iris; in an embodiment, a sensor (such as a three-axis acceleration sensor or a gyroscope) worn on the limbs of the human body can be used to sense the user's body movement, such as walking, running, dancing and so on.

The first non-transitory computer readable storage medium 122 is configured to store a plurality of first computer readable instructions. In actual implementation, the first non-transitory computer readable storage medium 122 includes a hard disk, an optical disk, a flash memory or the like. In addition, the first computer readable instruction means an instruction which can be interpreted and executed by the client-end host 120 (such as a computer in client-end device).

The first hardware processor 123 is electrically connected to the first non-transitory computer readable storage medium 122 and the sensor 121, and configured to execute the plurality of first computer readable instructions to make the client-end host 120 continuously transmit the client behavior state and multiple on-demand conversation settings. The on-demand conversation setting includes a time message and a filtering parameter. The time message can include, for example, year, month, day, hours, minutes, seconds, and even time intervals, and can be used as a basis of determining the answer message associated with time, for example, the time message can be used for determining whether the answer message is expired, setting periodic feedback (for example, sending an on-demand conversation message reminding you to eat at 12 am every day), or other time-related situations; for example, the time in the morning is associated with breakfast, the period from 0:00 am to 4:00 am is associated with sleep, and national holidays are associated with fixed dates, a birthday is associated with a specified date, etc. Therefore, when the time falls within the morning scope, the answer message related to breakfast is filtered out; when the time is within between 0:00 am and 4:00 am, the answer message related to sleep is filtered out; when the time is a national holiday, the answer message containing this national holiday is filtered out. In addition, the filtering parameter can be used, for example, to set the answer message which is permitted to receive, and the answer message which is rejected to receive; in other words, the user can be set the filtering parameter according to his preference, for example, the filtering parameter can be set to filter out chat content containing politics and religion, or only receive entertainment chat content, or filter out the content with frustration statement.

The server-end host 130 is connected to the client-end host 120 and configured to receive the client behavior state and the on-demand conversation setting. The server-end host 130 includes a question optimization circuit 131, a second non-transitory computer readable storage medium 132, and a second hardware processor 133. The question optimization circuit 131 includes a plurality of registers for storing states of finite state machines, a first combinational logic circuit for determining a state transition, and a second combinational logic circuit for determining an output to form a first finite state machine and a second finite state machine which are connected in series. The first finite state machine receives a rough question message and the answer message, an output of the first finite state machine is used as an input of the second finite state machine, and the second finite state machine outputs a precise question message to the artificial intelligence platform 110 through the application programming interface. In an embodiment, for example, the first finite state machine can be a Mealy-machine finite state machine, and an output of the first finite state machine is affected by a current stare, the rough question message and the answer message; the second finite state machine can be a Moore-machine finite state machine, and an output of the second finite state machine is affected by a current state. In practice, each on-demand conversation setting can be transited into a state table first, a flip-flop transition table is then set based on a flip-flop excitation table, and a Karnaugh map can be used to obtain an input equation of each flip-flop, so as to generate the circuit of the finite state machine, thereby realizing the question optimization circuit 131.

The second non-transitory computer readable storage medium 132 is configured to store a plurality of second computer readable instructions. In actual implementation, the second non-transitory computer readable storage medium 132 is similar to the first non-transitory computer readable storage medium 122, and the difference between the second non-transitory computer readable storage medium 132 and the first non-transitory computer readable storage medium 122 is that the second non-transitory computer readable storage medium 132 is a non-transitory computer readable storage medium of the server-end host 130 for storing the computer readable instruction (that is, second computer readable instruction) executed by the server-end host 130, and the first non-transitory computer readable storage medium 122 is the non-transitory computer readable storage medium of the client-end host 120 for storing the computer readable instruction (that is, the first computer readable instruction) executed by the client-end host 120.

The second hardware processor 133 is electrically connected to the second non-transitory computer readable storage medium 132 and the question optimization circuit 131, and configured to execute the plurality of second computer readable instructions to make the server-end host 130 execute: generating a rough question message having a natural language structure based on the received client behavior state and on-demand conversation setting, and inputting the rough question message to the question optimization circuit 131; after the question optimization circuit 131 inputs the precise question message to the artificial intelligence platform 110, receiving the answer message corresponding to the precise question message from the artificial intelligence platform 110, and inputting the answer message to a trained emotion AI model to generate an emotional answer message, and storing the emotional answer message to an answer list; automatically filtering out the emotional answer message matching the time message and the filtering parameter from the answer list as the on-demand conversation message which is generated based on the on-demand conversation setting, and transmitting the on-demand conversation message to the client-end host 120 for output. For example, in a condition that the client behavior state received by the server-end host 130 is “excited” and the on-demand conversation setting includes time message “AM 08:00” and the filtering parameter is “excluding frustration statement”, the second hardware processor 133 generates the rough question message such as “excited, AM 08:00 and excluding frustration statement” based on the terms “excited”, “AM 08:00” and “excluding frustration statement”. Next, the rough question message is inputted to the question optimization circuit 131 to perform parsing, and the states of the finite state machines are transited. For example, a type of the question is defined based on “excited”, a specific time state of the question is defined based on “AM 08:00”, a scope of the question is defined based on “excluding frustration statement”, and then a precise question message is generated according to a pre-defined template or a syntax rule, for example, “please list five reasons to make you be excited and not depressed at 8 o'clock in the morning”, or “it is 8:00 in the morning, I am excited, any suggestions?”. Next, the precise question message is transmitted to the artificial intelligence platform 110 to obtain the corresponding answer message, the answer message is inputted to the question optimization circuit 131 to automatically identify the association between the question and the answer, thereby dynamically adjusting the state setting of the finite state machine. For example, less relevant question is automatically set to be replayed by more relevant question, so as to generate the precise question message. Furthermore, the answer message is also inputted to a trained emotion AI model to generate an emotional answer message, and the emotional answer message is stored in an answer list, so that the second hardware processor 133 can automatically filter out the answer message matching the time message and the filtering parameter from the answer list, as the on-demand conversation message. For example, in a condition that the user's excited emotion is regularly sensed at both 8 am and 6 pm and corresponding answer messages “good morning, please share your excitement with others” and “good evening, please share your excitement with others” are obtained, and these answer messages are used to generate emotional answer messages, such as “Come on, record your current excitement as soon as possible”, “Share your excitement with the world, it's never too late”, through the emotion AI model. These emotional answer messages are stored in the answer list, when the current time is evening, the answer message related to the morning is excluded, and only the answer message related to the evening is selected as the on-demand conversation message. The second hardware processor 133 drives the transmission element to actively transmit the on-demand conversation message to the client-end host 120, for output. In other words, when receiving the client behavior state, the server-end host 130 triggers the active on-demand conversation and filters out the matching emotional answer message as the on-demand conversation message based on the on-demand conversation setting.

It is to be particularly noted that, in actual implementation, the present invention can be implemented fully or partly based on hardware, for example, one or more module of the system can be implemented by integrated circuit chip, system on chip (SOC), a complex programmable logic device (CPLD), or a field programmable gate array (FPGA). The non-transitory computer readable storage medium of the present invention records computer readable program instructions, and the processor can execute the computer readable program instructions to implement concepts of the present invention. The non-transitory computer-readable storage medium can be a tangible apparatus for holding and storing the instructions executable of an instruction executing apparatus. The non-transitory computer-readable storage medium can be, but not limited to electronic storage apparatus, magnetic storage apparatus, optical storage apparatus, electromagnetic storage apparatus, semiconductor storage apparatus, or any appropriate combination thereof. More particularly, the computer-readable storage medium can include a hard disk, an RAM memory, a read-only-memory, a flash memory, an optical disk, a floppy disc or any appropriate combination thereof, but this exemplary list is not an exhaustive list. The non-transitory computer-readable storage medium is not interpreted as the instantaneous signal such a radio wave or other freely propagating electromagnetic wave, or electromagnetic wave propagated through waveguide, or other transmission medium (such as optical signal transmitted through fiber cable), or electric signal transmitted through electric wire. Furthermore, the computer readable program instruction can be downloaded from the non-transitory computer-readable storage medium to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, hub and/or gateway. The network card or network interface of each calculating/processing apparatus can receive the computer readable program instructions from network, and forward the computer readable program instruction to store in non-transitory computer-readable storage medium of each calculating/processing apparatus. The computer program instructions for executing the operation of the present invention can include source code or object code programmed by assembly language instructions, instruction-set-structure instructions, machine instructions, machine-related instructions, micro instructions, firmware instructions or any combination of one or more programming language. The programming language include object oriented programming language, such as Common Lisp, Python, C++, Objective-C, Smalltalk, Delphi, Java, Swift, C#, Perl, Ruby, and PHP, or regular procedural programming language such as C language or similar programming language.

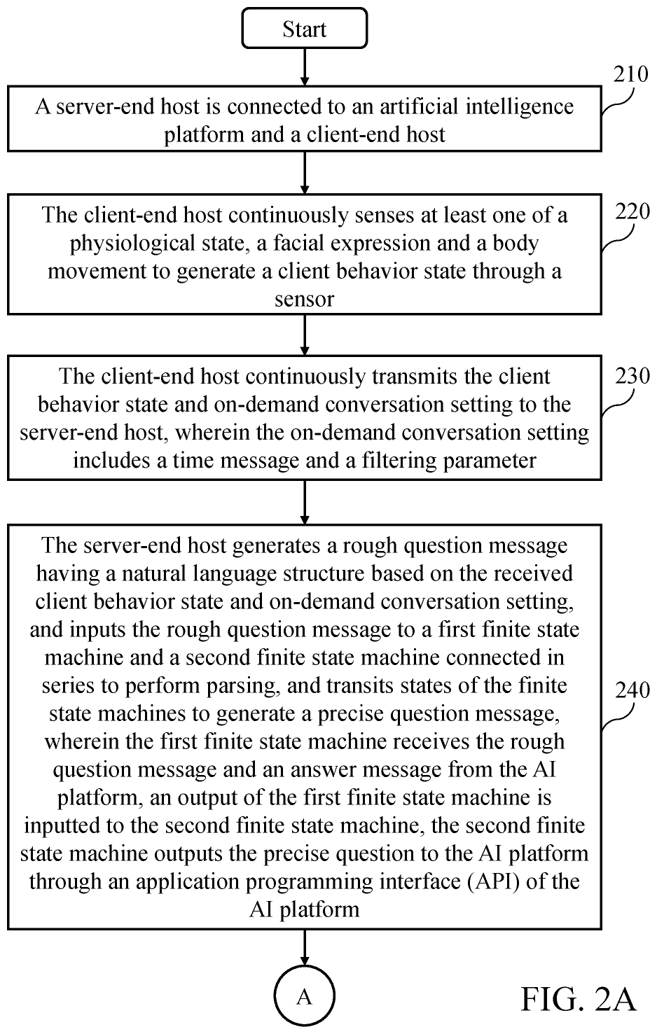

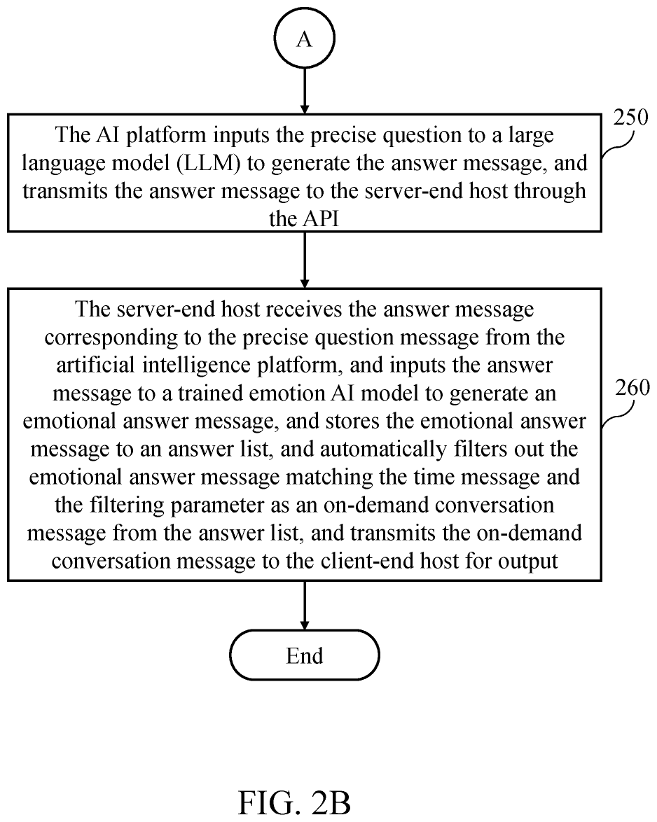

Please refer to FIG. 2A and FIG. 2B, which are flowcharts of an active chatbot method with composite finite state machine, according to the present invention. As shown in FIG. 2A and FIG. 2B, the active chatbot method includes the following steps. In a step 210, a server-end host 130 is connected to an artificial intelligence platform 110 and a client-end host 120. In a step 220, the client-end host 120 continuously senses at least one of a physiological state, a facial expression and a body movement to generate a client behavior state through a sensor 121. In a step 230, the client-end host 120 continuously transmits the client behavior state and on-demand conversation setting to the server-end host 130, wherein the on-demand conversation setting includes a time message and a filtering parameter. In a step 240, the server-end host 130 generates a rough question message having a natural language structure based on the received client behavior state and on-demand conversation setting, and inputs the rough question message to a first finite state machine and a second finite state machine connected in series to perform parsing, and transits states of the finite state machines to generate a precise question message, wherein the first finite state machine receives the rough question message and an answer message from the AI platform 110, an output of the first finite state machine is inputted to the second finite state machine, the second finite state machine outputs the precise question to the AI platform 110 through an application programming interface (API) of the AI platform 110. In a step 250, the AI platform 110 inputs the precise question to a large language model (LLM) to generate the answer message, and transmits the answer message to the server-end host 130 through the API. In a step 260, the server-end host 130 receives the answer message corresponding to the precise question message from the artificial intelligence platform 110, and inputs the answer message to a trained emotion AI model to generate an emotional answer message, and stores the emotional answer message to an answer list, and automatically filters out the emotional answer message matching the time message and the filtering parameter as an on-demand conversation message from the answer list, and transmits the on-demand conversation message to the client-end host for output. Through aforementioned steps, the rough question message having the natural language structure can be generated based on the client behavior state and the on-demand conversation setting, and the rough question message is inputted to the question optimization circuit to generate the precise question message, and the precise question message is transmitted to the artificial intelligence platform to obtain the corresponding answer message, the answer message is inputted to the trained emotional AI model to generate the emotional answer message and the emotional answer message is stored in the answer list, so that the emotional answer message matching the on-demand conversation setting can be filtered out as the on-demand conversation message, the on-demand conversation message is transmitted to the client-end host for output.

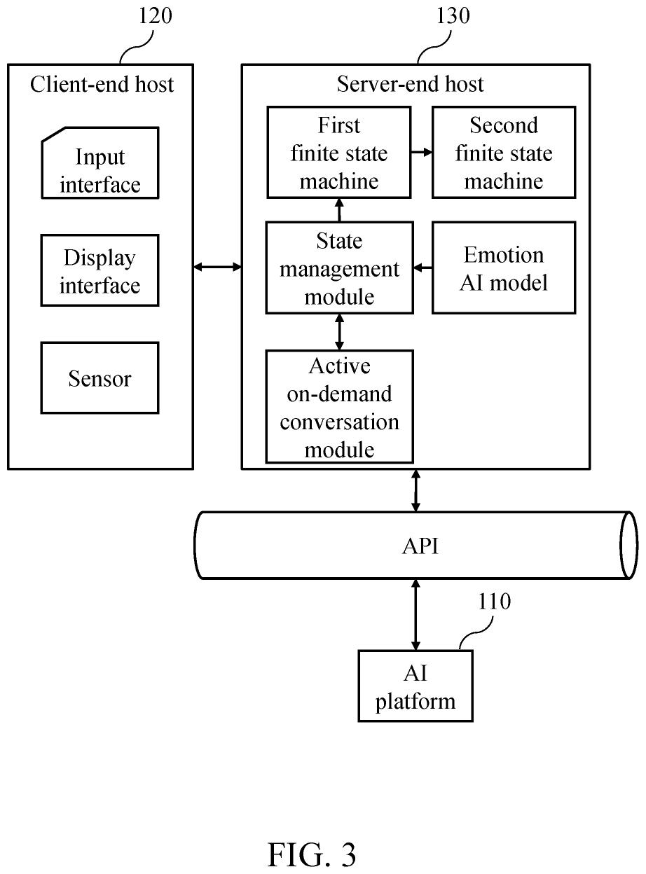

The embodiment of the present invention is described in the following paragraphs with reference to FIG. 3 to FIG. 5. Please refer to FIG. 3, which is a schematic view of an active chatbot of the present invention. The server-end host 130 is connected to the artificial intelligence platform 110 and the client-end host 120. The client-end host 120 continuously senses at least one of a user's physiological state, facial expression and body movement to generate a client behavior state, and continuously transmits the client behavior state and multiple on-demand conversation settings to the server-end host 130 through an input interface, the on-demand conversation settings include a time message and a filtering parameter. A state management module of the server-end host 130 generates the rough question message having the natural language structure based on the received client behavior state and on-demand conversation setting, and inputs the generated rough question message to a first finite state machine (such as Mealy-machine finite state machine) and a second finite state machine (such as Moore-machine finite state machine) to perform parsing and transit the states of the first finite state machine and the second finite state machine, so as to generate the precise question message, wherein the first finite state machine and the second finite state machine are connected in series. Next, the precise question message is transmitted to the artificial intelligence platform 110 through the API of the artificial intelligence platform 110. The artificial intelligence platform 110 inputs the precise question message to the large language model to generate an answer message, and transmits the answer message to the server-end host 130 through the API. After the server-end host 130 receives the answer message corresponding to the precise question message from the artificial intelligence platform 110, the server-end host 130 inputs the answer to the first finite state machine to check the association between the question and the answer to further optimize the rough question message to the precise question message, and inputs the answer message to a trained emotion AI platform to generate a corresponding emotional answer message, and stores the emotional answer message to the answer list, and actively filters out the emotional answer message matching the on-demand conversation setting (that is, the time message and the filtering parameter) as the on-demand conversation message from the answer list, transmits the filtered on-demand conversation message to the client-end host 120 for output through an display interface 510. Therefore, the chatbot completes the active and emotional human-machine interaction with the user by actively transmitting the on-demand conversation message according to the sensed client behavior state. Particularly, it should be noted that the state management module, the emotional AI model and the active on-demand conversation module are implemented by executing computer readable instruction by the hardware processor. In actual implementation, the trained emotional AI model is trained by an artificial intelligence (AI) neural network with training data having emotional labels, such as joy, worry, and anger and so on; the AI neural network can be, for example but not limited, convolutional neural networks (CNN), recurrent neural networks (RNN), long short-term memory (LSTM), transformer, or the like. When the answer message without emotion is inputted into the trained emotional AI model, the trained emotional AI model can generate an emotional answer message with emotion, that is, emotional words (such as vocabulary, idioms, adjectives) are embedded in the answer message to express glad (such as happy), anger (such as angry, dissatisfied), sad (such as depressed), joy (such as delightful, ecstatic), excitement (such as: hardly waiting to do something, agitation), surprised (such as: accident, dumbfounded), grateful (such as: sincerely thank-you, thanksgiving). However, it should be noted that the generated emotional response messages only appear to be emotional, it does not mean that the emotional AI model has emotion. In addition, methods such as backpropagation algorithm and gradient descent can also be used for optimization during the training process.

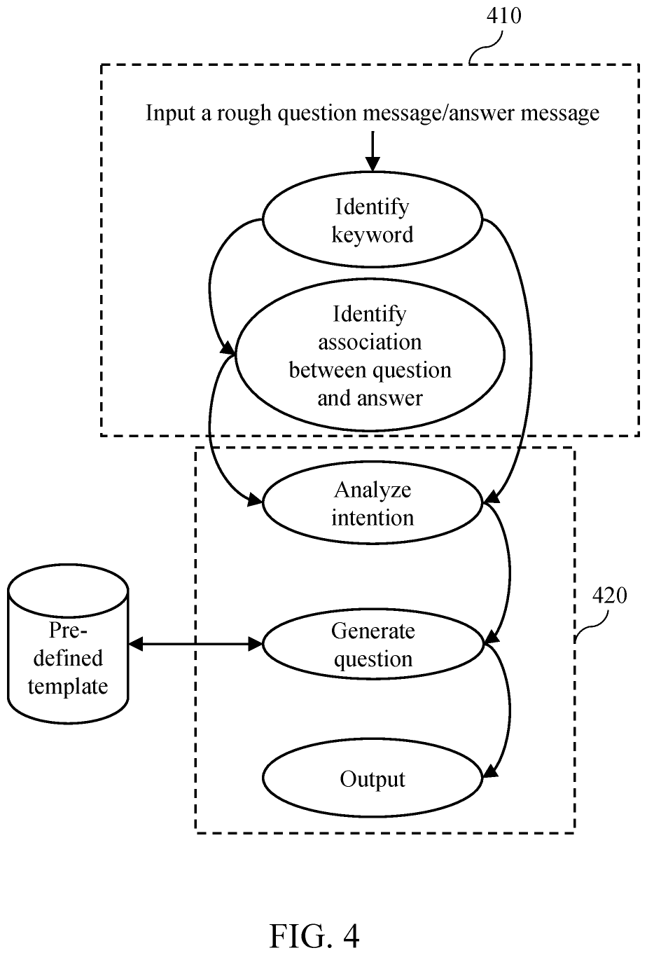

As shown in FIG. 4, which is a schematic view of a composite finite state machine of the present invention. In actual implementation, the Mealy-machine finite state machine 410 and the Moore-machine finite state machine 420 connected in series can be regarded as a composite finite state machine. After a rough question message is generated, the Mealy-machine finite state machine 410 can be used to identify keywords in the rough question message, and detects the presence of specific types of keywords, such as “behavior”, “mood”, “time”, etc. When the presence of these types of keywords is detected, the Mealy-machine finite state machine 410 enters a corresponding state and outputs the keywords. Next, the Moore-machine finite state machine 420 is used to further analyze the user's intention based on the keywords outputted in the previous step, and the Moore-machine finite state machine 420 can identify specific question types based on the combination and context of the keywords to generate a precise question message, such as “What are the reasons for feeling excited?”, “What suggestions do you have for exercise?”, “What choices do you have in the morning?”. Next, the server-end host 130 outputs the precise question message to the AI platform 110 to obtain corresponding answer message. When the server-end host 130 obtains the answer message, the server-end host 130 transmits the answer message to the Mealey-machine finite state machine 410, to identify the association between the question message and the answer message for providing the Moore-machine finite state machine 420 to analyze the intention and improve the generated question (such as the precise question message).

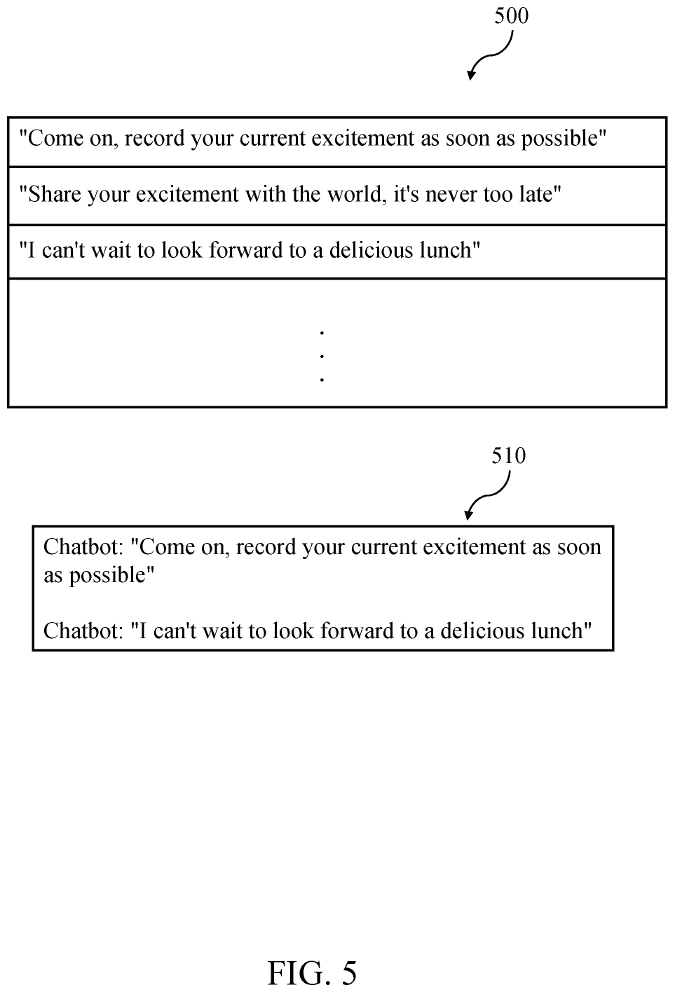

As shown in FIG. 5, which is a schematic view showing an operation of actively filtering out an emotional answer message from an answer list, according to the present invention. In a condition that there are multiple answer messages in an answer list 500 and “morning” is added into the filtering parameter of the on-demand conversation setting, when the server-end host 130 performs active on-demand conversation, the server-end host 130 filters out the first emotional answer message in the answer list 500 as the on-demand conversation message, because this emotional answer message has the keyword “morning”. In addition, in a condition that the time message of the on-demand conversation setting is set as “periodic feedback” and the time in the parameter is “12:00 noon”, when it is 12:00 noon now, the server-end host 130 filters out the emotional answer message related to “noon 12:00” as the on-demand conversation message, for example, “I can't wait to look forward to a delicious lunch”; in this message, “can't wait” and “look forward” are emotional terms, and “lunch” is related to twelve o'clock at noon. In this way, even if a client does not ask questions, the chatbot using the present invention can actively provide the on-demand emotional conversation message to the client according to the client behavior state or regular feedback, thereby effectively improving conversational flexibility and realism of chatbot.

According to the above-mentioned system and method of the present invention, the difference between the present invention and the conventional technology is that in the present the rough question message having the natural language structure is generated based on the client behavior state and the on-demand conversation setting, and the rough question message is inputted to the question optimization circuit to generate the precise question message, and the precise question message is transmitted to the artificial intelligence platform to obtain the corresponding answer message, the answer message is inputted to the trained emotional AI model to generate the emotional answer message and the emotional answer message is stored in the answer list, so that the emotional answer message matching the on-demand conversation setting can be filtered out as the on-demand conversation message, the on-demand conversation message is transmitted to the client-end host for output. Therefore, the technical solution of the present invention is able to solve the conventional problem, and achieve the technical effect of improving conversational flexibility and realism of a chatbot.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. An active chatbot system with composite finite state machine, comprising:
an artificial intelligence platform, configured to receive a precise question message through an application programming interface (API) and input the precise question message to a large language model to generate an answer message, and transmit the answer message through the application programming interface;
a client-end host, comprising:
at least one sensor, configured to continuously sense at least one of a physiological state, a facial expression and a body movement, to generate a client behavior state;
a first non-transitory computer readable storage medium, configured to store a plurality of first computer readable instructions; and
a first hardware processor, electrically connected to the first non-transitory computer readable storage medium and the at least one sensor, and configured to execute the plurality of first computer readable instructions to make the client-end host continuously transmit the client behavior state and on-demand conversation setting, wherein the on-demand conversation setting comprises a time message and a filtering parameter; and
a server-end host, connected to the client-end host and configured to receive the client behavior state and the on-demand conversation setting, wherein the server-end host comprises:
a question optimization circuit, comprising a plurality of registers for storing states, a first combinational logic circuit for determining a state transition and a second combinational logic circuit for determining an output to form a first finite state machine and a second finite state machine which are connected in series, wherein the first finite state machine receives a rough question message and the answer message, an output of the first finite state machine is used as an input of the second finite state machine, and the second finite state machine outputs the precise question message to the artificial intelligence platform through the application programming interface;
a second non-transitory computer readable storage medium, configured to store a plurality of second computer readable instructions; and
a second hardware processor, electrically connected to the second non-transitory computer readable storage medium and the question optimization circuit, and configured to execute the plurality of second computer readable instructions to make the server-end host execute:
generating a rough question message having a natural language structure based on the received client behavior state and on-demand conversation setting, and inputting the rough question message to the question optimization circuit;
after the question optimization circuit inputs the precise question message to the artificial intelligence platform, receiving the answer message corresponding to the precise question message from the artificial intelligence platform, and inputting the answer message to a trained emotion AI model to generate an emotional answer message, and storing the emotional answer message to an answer list; and
automatically filtering out the emotional answer message matching the time message and the filtering parameter from the answer list as the on-demand conversation message generated based on the on-demand conversation setting, and transmitting the on-demand conversation message to the client-end host for output.

2. The active chatbot system with composite finite state machine according to claim 1, wherein the server-end host selects at least one of a natural language processing (NLP), a generative model and a template matching to generate the rough question message having the natural language structure.

3. The active chatbot system with composite finite state machine according to claim 1, wherein the first finite state machine and the second finite state machine perform parsing on the rough question message to generate a key word and a syntax structure, and transit the states thereof to determine a question type based on a parsing result, and use a pre-defined template or a syntax rule to generate the precise question message which is more specific and clearer than the rough question message.

4. The active chatbot system with composite finite state machine according to claim 1, wherein the first finite state machine is a Mealy-machine finite state machine, and the output of the first finite state machine is affected by a current stare, the rough question message and the answer message, wherein the second finite state machine is a Moore-machine finite state machine, and an output of the second finite state machine is affected by a current state.

5. The active chatbot system with composite finite state machine according to claim 1, wherein the filtering parameter is configured to set the answer message which is permitted to receive, and the answer message which is rejected to receive, wherein the time message is used as a basis of determining the answer message associated with time.

6. An active chatbot method with composite finite state machine, comprising:
connecting a server-end host to an artificial intelligence (AI) platform and a client-end host;
continuously sensing at least one of a physiological state, a facial expression and a body movement to generate a client behavior state through a sensor, by the client-end host;
continuously transmitting the client behavior state and on-demand conversation setting to the server-end host, by the client-end host, wherein the on-demand conversation setting comprises a time message and a filtering parameter;
generating a rough question message having a natural language structure based on the received client behavior state and on-demand conversation setting, and inputting the rough question message to a first finite state machine and a second finite state machine connected in series to perform parsing, and transiting states of the first finite state machine and the second finite state machine to generate a precise question message, by the server-end host, wherein the first finite state machine receives the rough question message and an answer message from the AI platform, an output of the first finite state machine is inputted to the second finite state machine, the second finite state machine outputs the precise question to the AI platform through an application programming interface (API) of the AI platform;
inputting the precise question message to the large language model to generate the answer message, and transmitting the answer message to the server-end host through the application programming interface, by the artificial intelligence platform; and
receiving the answer message corresponding to the precise question message from the artificial intelligence platform, inputting the answer message to a trained emotion AI model to generate an emotional answer message, and storing the emotional answer message to an answer list, automatically filtering out the emotional answer message matching the time message and the filtering parameter as an on-demand conversation message from the answer list, and transmitting the on-demand conversation message to the client-end host for output, by the server-end host.

7. The active chatbot method with composite finite state machine according to claim 6, wherein the server-end host selects at least one of a natural language processing (NLP), a generative model and a template matching to generate the rough question message having the natural language structure.

8. The active chatbot method with composite finite state machine according to claim 6, wherein the first finite state machine and the second finite state machine perform parsing on the rough question message to generate a key word and a syntax structure, and transit states thereof to determine a question type based on a parsing result, and a pre-defined template or a syntax rule is used to generate the precise question message which is more specific and clearer than the rough question message.

9. The active chatbot method with composite finite state machine according to claim 6, wherein the first finite state machine is a Mealy-machine finite state machine, and the output of the first finite state machine is affected by a current stare, the rough question message and the answer message, wherein the second finite state machine is a Moore-machine finite state machine, and an output of the second finite state machine is affected by a current state.

10. The active chatbot method with composite finite state machine according to claim 6, wherein the filtering parameter is configured to set the answer message which is permitted to receive, and the answer message which is rejected to receive, wherein the time message is used as a basis of determining the answer message associated with time.
